(19) United States
(12) Patent Application Publication
(10) Pub. No.: US 2004/0014518 A1
(43) Pub. Date: Jan. 22, 2004

(54) Gaming apparatus and gaming apparatus control method

(76) Inventor: Hideaki Iwamoto, Tokyo (JP)

Correspondence Address: THE LAW OFFICE OF JOHN A. GRIECCI, 703 PIER AVE., SUITE B #657, HERMOSA BEACH, CA, 90254, US

(21) Appl. No.: 10/400,135

(22) Filed: Mar. 25, 2003

(30) Foreign Application Priority Data
Jul. 17, 2002 (JP) 2002-208805

(51) Int. Cl. A63F 13/00

(52) U.S. Cl. 463/20

(57) ABSTRACT

When the doghouse symbol T5 is displayed on the display region E2 stopping at last, Toby image 42 running from a doghouse symbol T5 toward display region A2 is displayed, The display that Toby image 42 jumps into the display region A2 is made, and a regular symbol displayed on the display region A2 changes into Toby symbol T2. The chance games are executed three times in maximum

Therefore, it is possible to provide a gaming apparatus whose attractiveness is enhanced by making the displaying on a display announcing a game's state various.

### FIELD OF THE INVENTION

The present invention relates to a gaming apparatus which notifies a player of a game state by displaying a symbol on a plurality of display regions, a control method of a gaming apparatus, a program and a recording medium readable by a computer.

### RELATED ART

A slot machine is cited as a representative gaming apparatus in which it is judged whether a winning prize condition is satisfied or not, and a symbol is shown in each of a plurality of display regions, and it is announced to a player whether a winning prize condition is satisfied or not. For such a slot machine, as a policy to attract the interest of a player, the one in which a higher payment rate of coins and the like is achieved by a bonus game is more popular than a game machine performing merely so-called basic game. Since the strength and weakness can be added to a rate of the paid prize money and medals by providing such a bonus game in addition to a basic game, the attractiveness is surely increased compared to the gaming apparatus which performs merely a basic game. For example, in a conventional slot machine, whether a bonus game will be performed or not is announced to a player by a predetermined symbol being displayed in a plurality of display regions.

Usually a player is playing in the hope of a bonus game to be performed, and the judgment for shifting from a basic game to a bonus game is the greatest concern for a player. It is notified a player of whether a game is shifted to the bonus game or not by display on a display, but mere announcement that a bonus game will be performed may decrease the interest of a player demanding stimulation. Such a player demands the appearance of a gaming apparatus which increases a feeling of expectation of shifting to a bonus game.

Thus, it is an object of the present invention to provide a gaming apparatus whose attractiveness is enhanced by making a display announcing a game state diverse, a control method of a gaming apparatus, a program and a recording medium readable by a computer.

### SUMMARY OF THE INVENTION

A gaming apparatus according to the present invention that solves the problem mentioned above comprises a display having a plurality of display regions where a plurality of types of symbols are varyingly displayed and a controller which executes a specified program and controls the display contents of a display, and the controller determines a symbol from a plurality of types of symbols which should be displayed on each display region according to a program, halt-displays in turn a symbol in multiple display regions that is made displayed varyingly, executes the basic game for the winning prize judgment based on an array of a symbol displayed on each display region, and when a predetermined specific condition is satisfied, displays a predetermined symbol in the display region where the varying display stops at last among the display regions wherein a plurality of varying displays stop to perform a game different from the basic game.

In a gaming apparatus according to the present invention wherein the basic game and a game different there from are executed, a different game other than the monotonous basic game is prepared, so that a player expects a shift to a different game. When the game is shifted to a different one, a predetermined symbol is displayed on the display region where varying display stops at last among the display regions where varying displays stop. Therefore, a player can expect a shift to a different game until varying display stops, thereby raising the attractiveness thereof as much. Herein, in a preferable embodiment, the predetermined symbol shall be displayed only in the display region where varying display stops at last among a plurality of display regions.

In the present invention, a predetermined symbol to announce a shift to a different game is not provided in display regions other than the display region where varying display stops last, and it is made possible to display a predetermined symbol only on the display region where varying display stops last.

Therefore, it is possible to raise a feeling of satisfaction for a shift to a different game by seeing this predetermined symbol at last because a player does not see a predetermined symbol to announce a shift to a different game until all symbols are displayed. Therefore, it is possible to raise an attractiveness of a game further more.

Moreover, in a preferable embodiment, it is desirable, after having displayed a predetermined symbol, to move a specified pattern from a predetermined symbol toward a display region other than the display region where a predetermined symbol has been displayed among a plurality of display regions.

It is possible for a player to arouse the sense of superiority when the game is shifted to a different game by making a specified pattern motion-display from the predetermined symbol which stops at last toward other display regions. As a result, it is possible to make a highly attractive game.

Moreover, according to the present invention which has solved the above-described problems, a control method of a gaming apparatus; comprising a display having a plurality of display regions where a plurality of types of symbols is displayed varyingly, and a controller executing a predetermined program and controlling a display content said display; comprises the steps of, determining said symbol which should be displayed on each said display region among the symbols of said plural types, sequentially stopping the display of a symbol in said plural display region displayed varyingly, executing a basic game judging a prize based on an arrangement of symbols displayed on each said display region, displaying a predetermined symbol in the display region where the varying display stops last among said plural display regions where the varying display stops when a predetermined condition is fulfilled and executing an attractive game different from said basic game.

In a control method of a gaming apparatus according to the present invention, a basic game and a game different there from are performed, and, if a game other than the monotonous basic game is prepared, a player will expect a shift to a different game. And because a predetermined symbol is displayed on the display region where the varying display stops at last when the shift to a different game is made, a player can continuously expect a shift to a different game until the varying display stops at last. Therefore, it is possible to maintain a feeling of expectation of a player for a long period of time, and the attractiveness is raised as much.

Moreover, it is preferable that, after a predetermined symbol is displayed, the step is executed in which a specified pattern is motion-displayed transferred from a predetermined symbol toward a display region other than the display region where a predetermined symbol has been displayed among a plurality of display regions. In this way, it is possible to arouse a sense of superiority for a player when the game is shifted to a different game by motion-displaying a specified pattern from the predetermined symbol which has stopped at last toward other display regions. As a result, it is possible to make a highly attractive game.

Furthermore, a program according to the present invention solves the aforementioned problem and allows the computer to execute the steps of; displaying a multiple display region where multiple type symbols are displayed on a display movably, determining a symbol to be displayed on each display region from multiple type symbols, halt-displaying a symbol in multiple display regions displayed varyingly in turn, executing a basic game in which a winning prize is judged based on the array of a displayed symbol, displaying a predetermined symbol on the display region where the varying display is stopped at last among the multiple display regions where the varying display is stopped when a predetermined specific condition is satisfied, and executing a game different from the basic one.

The recording medium readable by computer of the present invention is a medium in which the above-described program is recorded.

It is possible to obtain the effect that is described in the explanation of the gaming apparatus and the control method thereof by making a computer execute a program according to the present invention or a program recorded in a recording medium. Thus, it is possible to maintain a feeling of expectation for a long period of time when the game is shifted to a different one, thereby arousing a sense of superiority and enhancing a feeling of satisfaction further more. Other features and advantages of the invention will be apparent from the following description with reference to the accompanying drawings.

### BRIEF DESCRIPTION OF THE DRAWINGS

FIG. 1 is an outer perspective view of a gaming apparatus slot machine according to the embodiment of the present invention.

FIG. 2 is a block diagram showing a controller controlling a slot machine and various actuators electrically connected thereto.

FIG. 3 is a drawing showing a display screen on a display.

FIG. 4 is a drawing showing symbols displayed on each display region in enumeration.

FIG. 5A is a drawing showing an example of a pay line of a slot machine.

FIG. 5B is a drawing showing an example of a pay line of a slot machine.

FIG. 6 is a flowchart showing a flow of basic game of a slot machine according to this embodiment.

FIG. 7 is a flowchart showing a flow of a bonus game of a slot machine according to this embodiment.

FIG. 8 is a flowchart showing a flow of a chance game of a slot machine according to this embodiment.

FIG. 9 is a drawing showing a display screen of a display showing a symbol array to announce a start of a main bonus game.

FIG. 10 is a drawing showing a display screen of a display in the state where each reel image is varyingly displayed.

FIG. 11 is a drawing showing a display screen of a display when a doghouse image is displayed in the display region E2.

FIG. 12 is a drawing showing a display screen of a display in the state where a Toby image starts to run toward the display region A2 from a doghouse image.

FIG. 13 is a drawing showing a display screen on a display in the state where a Toby image jumps into the display region A2 with a smoke image being displayed.

FIG. 14 is a drawing showing a display screen on a display in the state where a Toby symbol is displayed in the display region A2.

FIG. 15 is a drawing showing a display screen on a display in the state where a reel image E is varyingly displayed after a Toby symbol has been displayed in the display region A2.

FIG. 16 is a drawing showing the display screen on the display where a Madonna symbol or Bulldog symbol is displayed in a display region.

FIG. 17 is a drawing of configuration showing each module of a program of the present invention.

FIG. 18 is a drawing showing the recording medium in which a program as shown in FIG. 17 is recorded that can be read by the computer (CD-ROM).

### PREFERRED EMBODIMENTS OF THE INVENTION

The preferable embodiment, of the present invention is explained based on an attached drawing hereafter in detail.

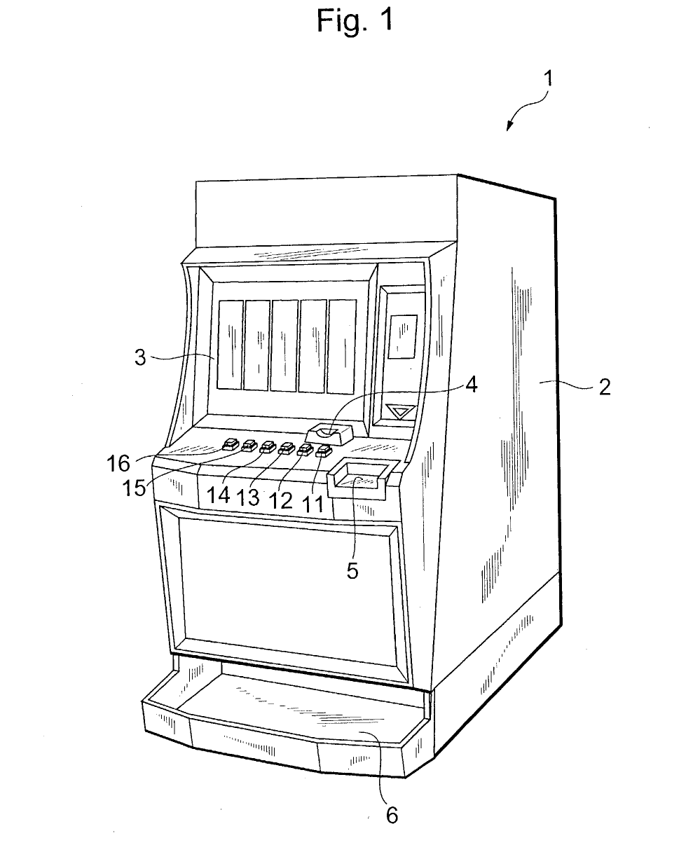

FIG. 1 is an entire perspective view showing a slot machine according to this embodiment. A slot machine 1, a gaming apparatus of the present invention, has a housing 2, which is provided with a display 3 comprising a liquid crystal display for digitally displaying a slot game. A coin slot 4 for dropping media such as medals and coins (“coin(s)” is a general term for these media hereafter) and a bill inserter 5 for inserting bills are provided in a front lower part of the display 3. A player can perform a slot game with either coin or bill. Of course, it is possible to allow a game to be performed only with coin or bill. Moreover, a coin receiving section 6 for a player to receive coins to be paid to him is provided in the lowest section of the housing 2.

Moreover, on the front side of the coin slot 4, six push buttons are arranged. These buttons are provided often on known slot game machines, comprising in the order from right a start button 11 to instruct the symbols to start to rotate, a BET button 12 to instruct 1 BET, a MAXBET button 13 to bet from the remaining credit to the maximum number of bet (for example 20), a REPEATBET button 14 to BET by the same number as the previous game, a collect button 15 to settle the coins which are acquired by the game, and a pay out button 16 to instruct to pay coins.

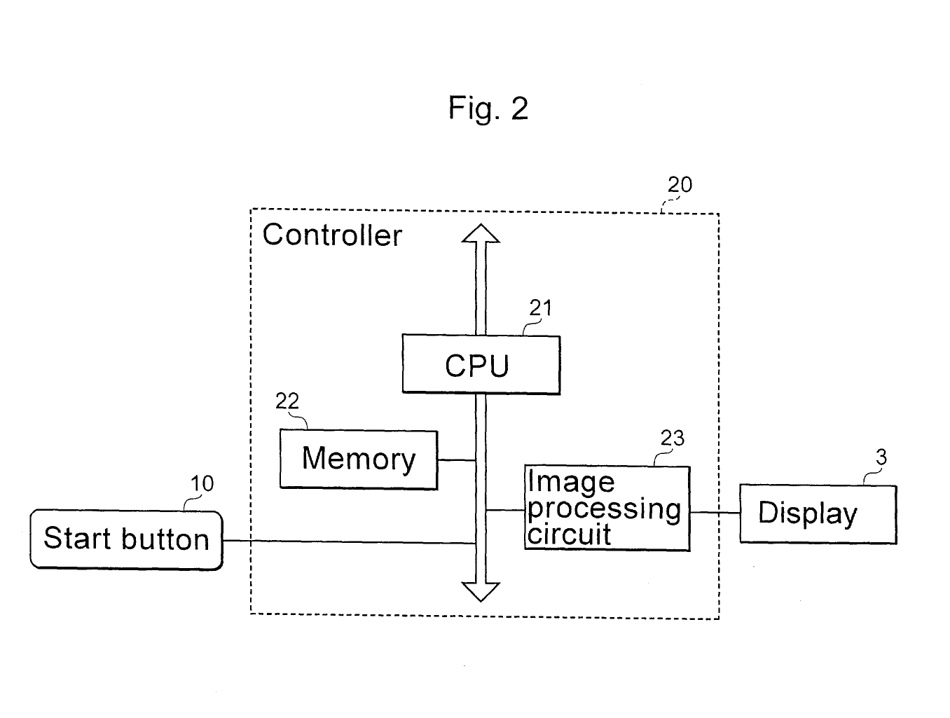

FIG. 2 is block diagram showing the controller controlling the processing of a slot machine and various actuators electrically connected thereto.

The controller 20 comprises a CPU21 supervising various controls of the slot machine, a memory 22 storing a program necessary for a slot game and data, a Video RAM, and an image processing circuit 23 controlling display contents of display 3. Moreover, I/O ports are arranged appropriately between CPU21 and each actuator.

Moreover, the memory 22 has ROM and RAM areas, and the ROM area includes, at least, a program having a module for executing a basic game and a bonus game, and data for a pay table displaying a dividend according to the symbol array and the symbol image. On the other hand, in the RAM area of memory 22 are written variable data such as the number of BET, the number of credit, etc. of the player.

Furthermore, a coin sensor to detect that a coin has been dropped and the start button 11 are connected to CPU21 through a bus. Various buttons and bill sensors not shown are also connected to the controller 20.

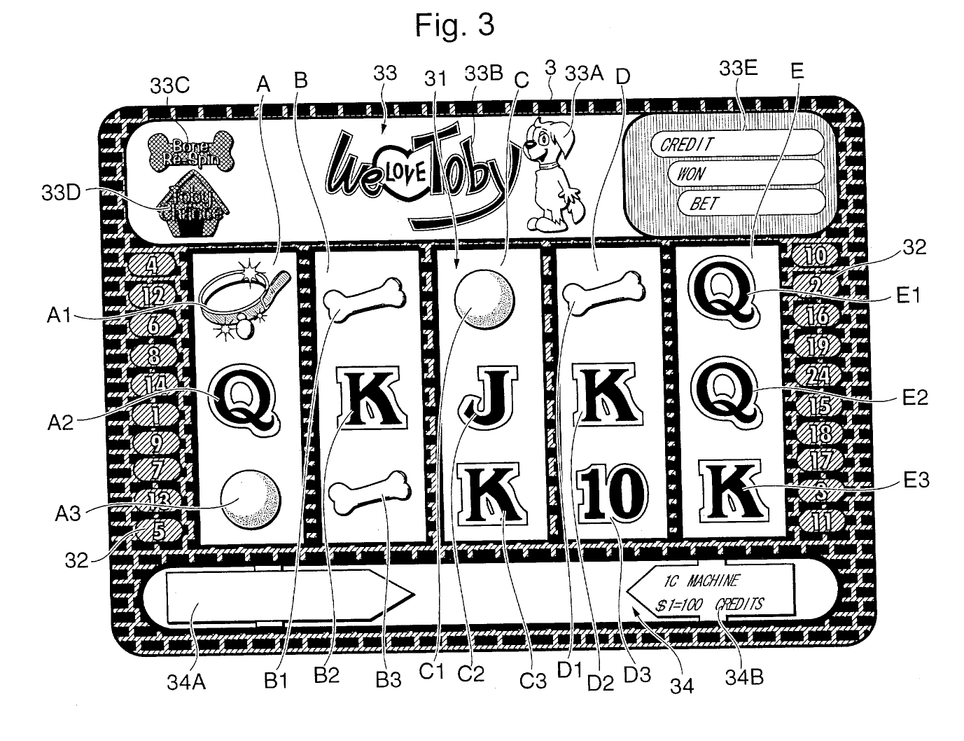

FIG. 3 is a drawing showing a display screen of display 3. In this embodiment, a display region section 31, a line number display 32, an upper part display 33, and a lower part display 34 are displayed respectively in display 3.

Fifteen display regions in total, in which a plurality of symbols is to be displayed, are provided in the display region 31 in three rows by five columns. Moreover, the turning reel images A through E in which symbols of a plurality of types are drawn are varyingly displayed, and the images are processed in such a manner that symbols which are chosen when each reel image stops are displayed on the display regions A1 through A3, B1 through B3, C1 through C3, D1 through D3, and E1 through E3.

In both sides of the display region section 31, the line number display 32 is displayed where a line number showing each pay line is displayed. Among line numbers displayed in the line number display 32, a number corresponding to the pay line which a player has chosen is displayed lighted, and the number that a player has not chosen remains unlighted.

An upper display 33 is formed above the display region section 31. In the center of upper display 33, the dog image 33A having a pet name of “Toby” a mascot of a slot machine of this embodiment, is displayed with the decoration letter image 33B of “WELOVETOBY” on its side. Moreover, on the upper left side of upper display 33, bone image 33C is displayed, and doghouse image 33D is displayed on the lower side of bone image 33C. Bone image 33C and doghouse image 33D are displayed lighted in the predetermined special game. Furthermore, an image of credit numbers is formed on the right side of upper display 33. In the mage of credit numbers, the numbers of credited coins, coins which can be obtained by one game, and coins which are betted in one game are displayed.

A lower display 34 is formed under the display region section 31. A letter information display 34A to display character information are formed at the left position of the lower display 34 to indicate the state, for example, when a chance and bonus games have been started. Furthermore, at the right side position of lower display 34, a rate display 34B is formed in which a rate charged for performing 1 BET is displayed.

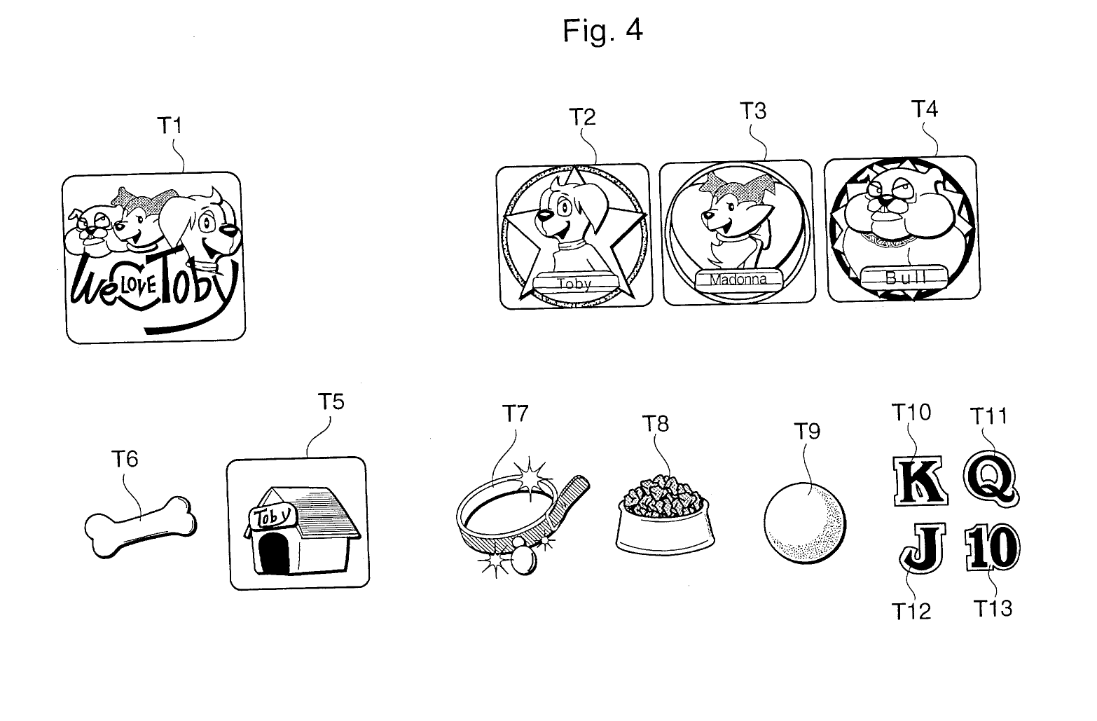

FIG. 4 is a drawing to enumerate symbols displayed on each display region. As the symbols in this embodiment, there are special symbols such as wild symbol T1, Toby symbol T2, Madonna symbol T3, bull symbol T4, doghouse symbol T5 and bone symbol T6.

Toby symbol T2 is a symbol of a male dog having a pet name of “Toby” used as a motif. Toby symbol T2 is set up only in the reel image A, and made possible to be displayed only in any of display regions A1 through A3 in which an varying display stops first. The state will be established in which it is possible to expect a bonus game because this Toby symbol T2 is displayed.

Madonna symbol T3 is a symbol of a female dog having a pet name of “Madonna” used as a motif. This Madonna symbol T3 is set up only in the reel image E, and made possible to be displayed only in any of display regions E1 through E3 in which an varying display stops at last. When Toby symbol T2 is displayed in any of display regions A1 through A3, a shift to Maine bonus game is announced by displaying Madonna symbol T3 in the same row as that of Toby symbol T2.

The bulldog symbol T4 is a symbol of a male dog having a pet name of “bulldog” set up only in the reel image E similarly as Madonna symbol T3, and it can be displayed only in the display regions E1 through E3. When Toby symbol T2 is displayed in any of display regions A1 through 3, a shift to a sub-bonus game is announced by displaying bulldog symbol T4 in the same row as that of Toby symbol T2. For both of these main bonus and sub-bonus games, a refund rate of coins (a payment rate) becomes higher than the basic game.

Wild symbol T1 is a symbol comprising all of these “Toby”, “a Madonna”, and “bulldog” symbols as well as a decoration character “WELOVETOBY” used as a motif. The wild symbol T1 is, so to speak, an almighty symbol, and set up in such a way that it can be considered as any of usual symbols as explained later.

Moreover, the doghouse symbol T5 is a symbol of a motif of a doghouse. When this symbol T5 is displayed in a display region, the animation cartoon in which Toby dashing out from the doghouse is displayed, making a symbol in other display regions change into Toby symbol T2. The bone symbol T6 is a symbol of a bone as a motif, and a turning cartoon film is shown if a specified condition is satisfied. Moreover, the bone symbol T6 displayed in the main bonus game that will be mentioned later among a bonus game has a role that all of them are changed into Wilde symbol T1 to be displayed.

Moreover, there are a collar symbol T7, hood symbol T8, ball symbol T9 and trump card mark symbol as a regular symbol. Card mark symbols include the King symbol T10, Queen symbol T11, Jack symbol T12 and a Number symbol T13.

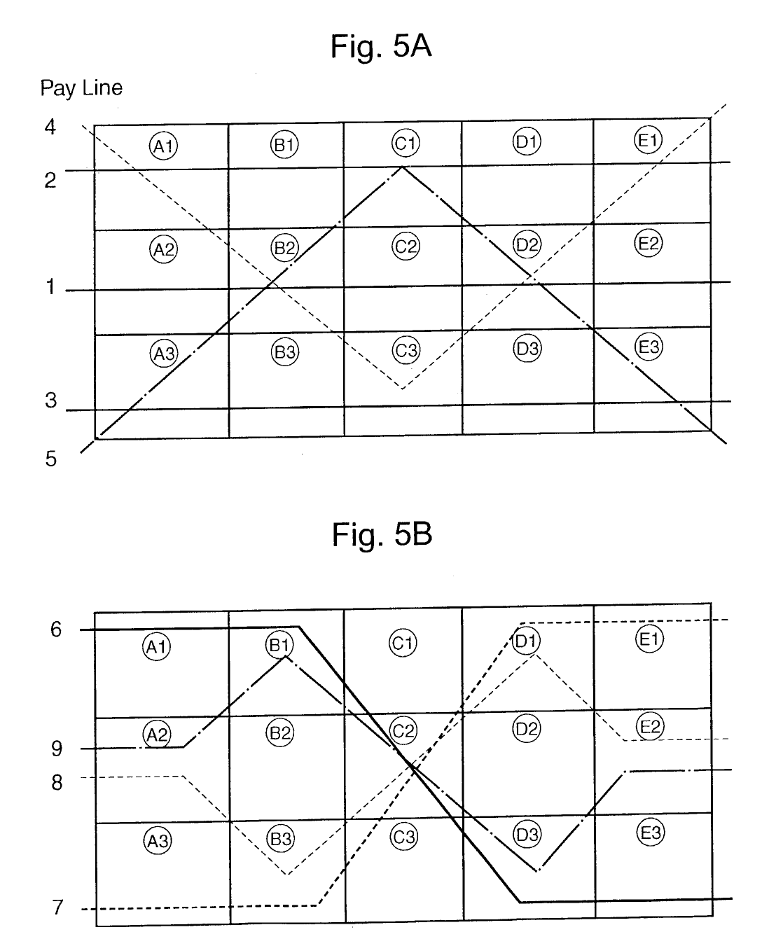

FIGS. 5A and 5B are drawings showing an example of a pay line of slot machine 1. For better understanding, pay line symbols are shown divided into two drawings. Nine pay lines are prepared as an example as shown in each drawing. When predetermined symbols are arranged on any of these pay lines, the dividend that matches the array contents is paid to a player. Moreover, though not shown, 11 pay lines are prepared in addition, 20 pay lines in total. In this way, various pay lines can be provided by increasing the number of lines to three rows by five columns in this embodiment. When a specified winning prize condition is satisfied, one kind among the normal symbols mentioned above is displayed in all display regions in one pay line, to announce the disbursement of the specified number of coins.

In the slot machine 1 according to this embodiment, a basic game and bonus game are prepared for the progress of the game. Among them, in this bonus game, a main bonus game called “Madonna future” and a sub-bonus game called “Bull future” are prepared. A winning prize judgment as to whether a bonus shift condition is satisfied or not is performed in CPU21, and if, a bonus shift condition is satisfied, a bonus game is executed. The bonus shift condition includes the first and second bonus shift conditions, and Maine bonus game will be executed when the first bonus shift condition is satisfied, and a sub-bonus game will be executed when the second bonus shift condition is satisfied. Moreover, in the slot machine 1, the coin payment rate in a bonus game is set up higher than that in the basic game. In particular, in a main bonus game, it is set up so that a coin payment rate will be higher than that in the sub-bonus game. Therefore, a player performs the basic game while hoping to shift to the main bonus game. Concrete contents of these bonus games and the judgment as to whether a bonus shift condition of these bonus games is satisfied or not and will be explained later.

Moreover, among pay lines of 20 set up in display regions A1 through A3, B1 through B3, C1 through C3, D1 through D3, and E1 through E3, the winning prize is judged based on whether the same symbols align in the pay line which is specified by a player. And, when the same symbols align with the pay line which a player specified, it is judged that a winning prize condition is satisfied, and payment of the specified number of coins is performed. In this winning prize judgment, the wild symbol T1 can be regarded as the symbol which is almighty for any symbols. Thus, the same number of cons will be paid even when only King symbol T10 and wild symbol T1 align in all display regions in one pay line in the same way as in the case where King symbol T10 aligns in all display regions in one pay line.

Moreover, a shift to a bonus game is announced to a player when the basic game is shifted to a bonus game by displaying a predetermined symbol on a display region. Specifically, when shifted to the main bonus game among bonus games, Toby symbol T2 is displayed in any of display regions A1 through A3, and, at the same time, Madonna symbol T3 is displayed in the display region out of E1 through E3 in the same row as that where the Toby symbol T2 is displayed. Moreover, when shifted to a sub-bonus game, Toby symbol T2 is displayed in any of display regions A1 through A3, and, at the same time, the bulldog symbol T4 is displayed in one out of display regions E1 through E3 in the same row as that where Toby symbol T2 is displayed.

Furthermore, in the slot machine 1 according to this embodiment, the chance game of the present invention that is a different game is set up in addition to the basic and bonus games. The chance game is a game to raise expectation of a player to a bonus game shift. The judgment of a shift to this chance game is also made by a judgment in CPU21, and the shifting to a chance game is made by satisfying a specific condition in a winning prize judgment. The specific contents and judgment as to whether the specific condition for a chance game is satisfied is explained later.

Controls of such basic and bonus games are performed by CPU21 of controller 20, memory 22, image processing circuit 23, and display 3 working in collaboration.

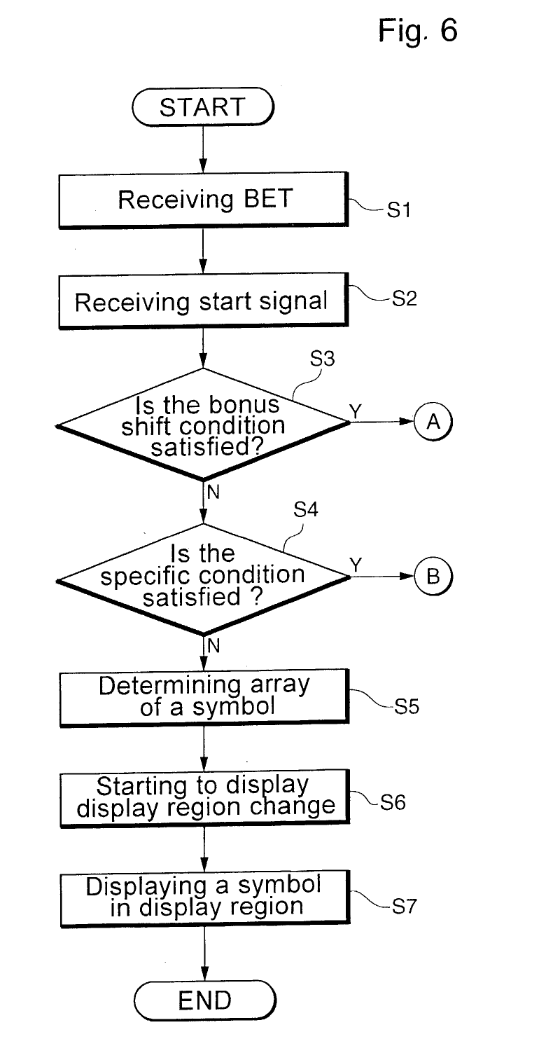

A control method of the slot machine 1 according to this embodiment is explained next. FIG. 6 is a flowchart showing the flow of the basic game of slot machine 1 according to this embodiment. At first, a flow of basic game is explained while referring to FIG. 6 and mentioning the judgment of performing a bonus game.

When the slot machine 1 is operated, CPU21 accesses memory 22 and transfers the information on the basic screen of slot machine 1 such as the frames forming a display region to the image processing circuit 23. In image processing circuit 23, after the information are stored in VideoRAM, display 3 appears. Thus, slot machine 1 is in a state where a player can perform the slot game. Because CPU21 executes a module about the slot game of a program stored in a memory 22, the following processing is performed. When the slot machine 1 is operated, a state is established where the basic game is performed as a slot game.

In step S1, CPU21 of controller 20 waits for BET of a player. BET can be performed with the remaining credit, and a player specifies the number of BET by using any of BET button 12, MAXBET button 13, and REPEATBET button 14.

A player pushes the start button 11 after BET is completed (S2). Then, CPU21 judges whether the bonus shift condition is satisfied before variable display is done to show how the reel turns (S3). Moreover, a similar judgment is performed without pushing the start button 11 when a player pushes the MAXBET button 13 or REPEATBET button 14. In this judgment, a random number value provided by a program stored in memory 22 is used.

For example, when a random number is generated in a range of integers 0-400 and a random number value of 1 is acquired as a random number value, a player can shift the game to a main bonus game considering that the second bonus shift condition is satisfied, and, when a random number value of 100 or 200 is acquired as a random number value, then the player can shift it to a sub-bonus game considering that the first bonus shifting bonus condition is satisfied. Moreover, a lottery on the basis of such a random number value may be performed in any timing. For example, a lot maybe drawn when the start button 11 is pushed, whenever BET button 12 is pushed, or after the reel images A through E has been variably displayed.

After a judgment is made as to whether a bonus shift condition is satisfied, a judgment as to whether a specific condition is satisfied is performed successively (S4). A judgment as to whether a specific condition is satisfied can be made by generating a plurality of random numbers similarly as in the judgment of a bonus shift condition and using a random number value acquired from these random numbers as a base. For example, it is judged that the specific condition is satisfied when a random number is generated in a range of integer 0-100 and a random number value of 100 is obtained.

After the judgment of a bonus shift condition and a specific condition is made in this way, an array of symbols to notify a player about a result of those judgments is decided in CPU21 (S5).

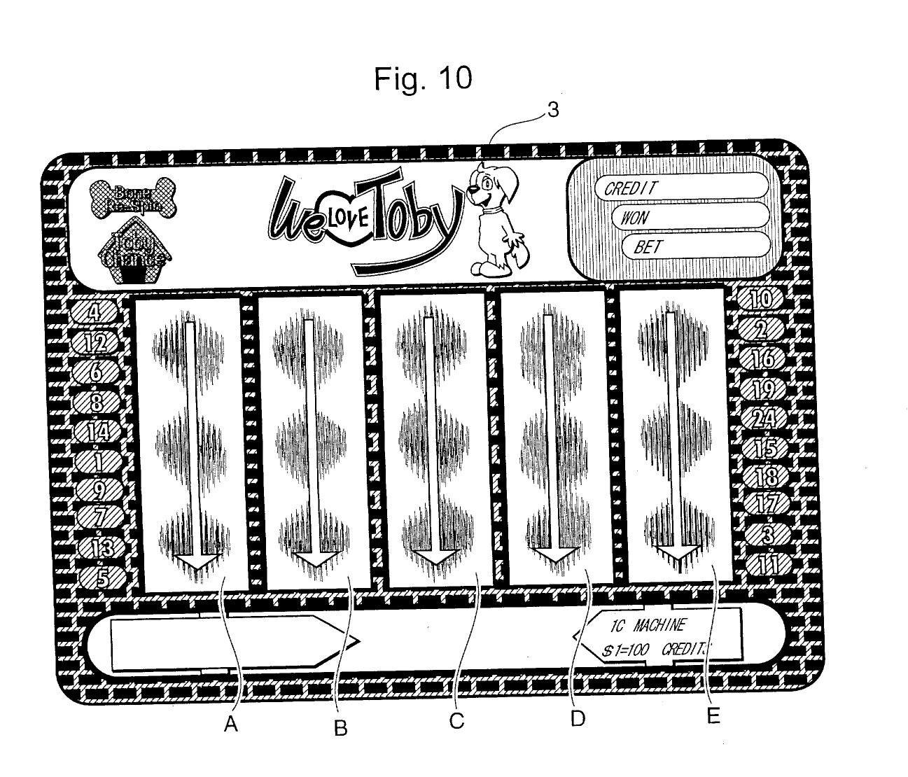

If an array of a symbol is determined, as shown in FIG. 10, displaying of display regions is started by variably displaying each of reel images A through E in display 3 (S6). In CPU21, an image processing circuit 23 is controlled to perform an image processing as if a real reel turns. And, a symbol decided beforehand is displayed in each display region by halt-displaying each of reel images A through E in this order, for example, as shown in FIG. 3(S7). And, a player watches this display and can know the result of the basic game, and, when the same normal symbols align within the pay line which a player has specified, then, disbursement of the specified number of coins is performed.

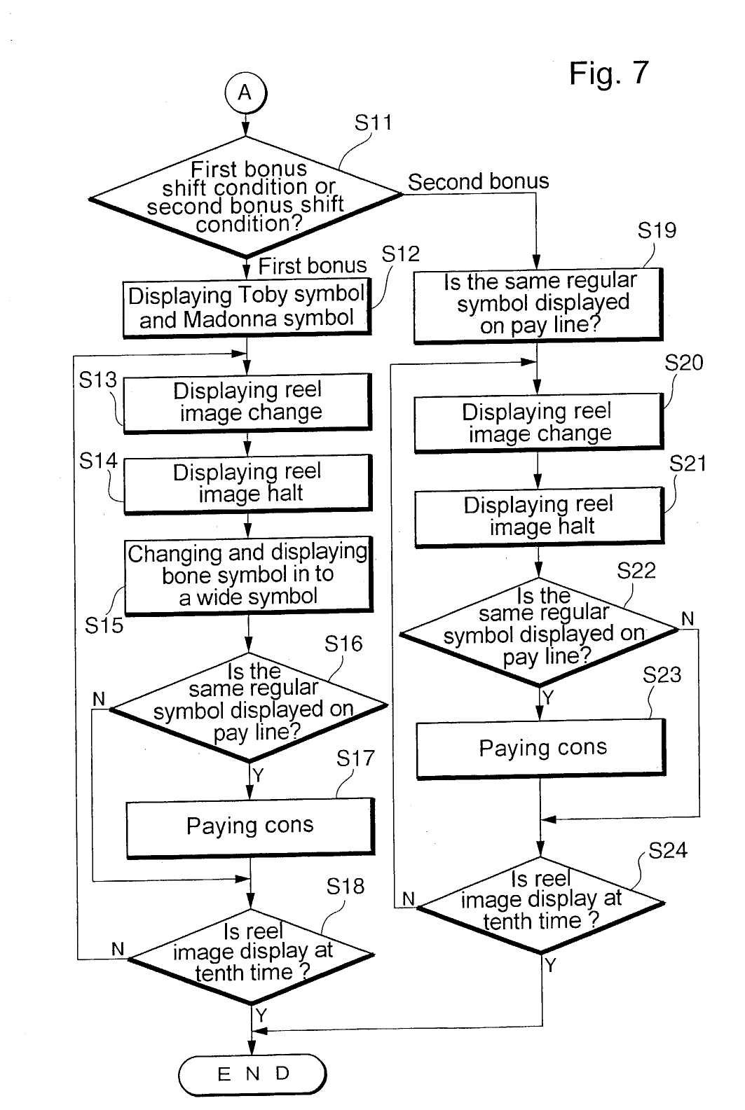

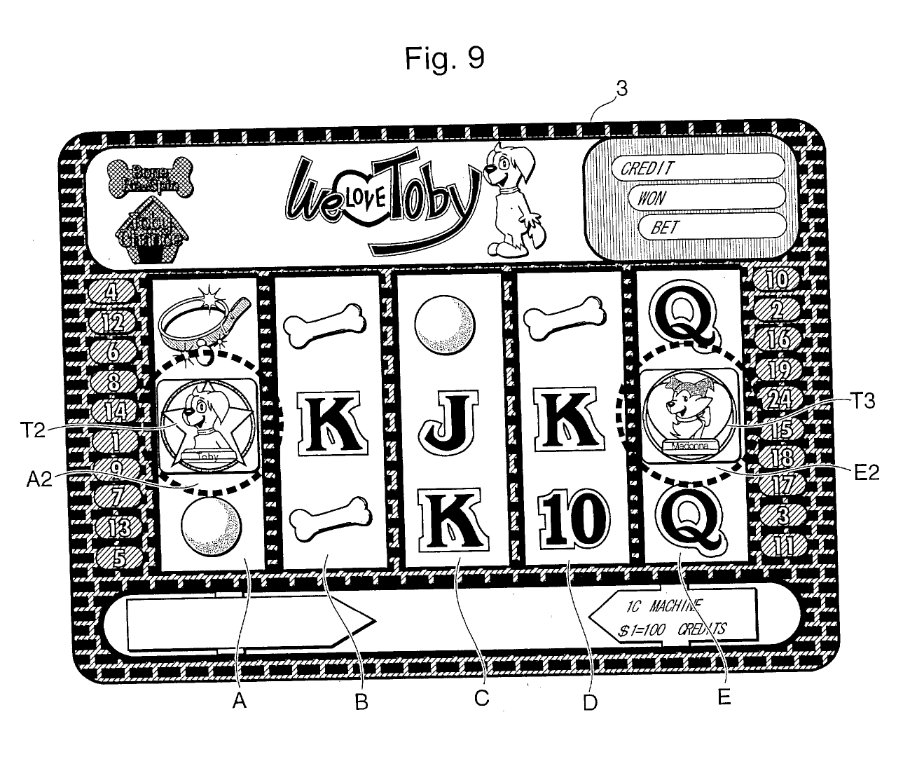

Then, a flow of a bonus game is explained referring to FIG. 7. The judgment as to whether any of the first bonus shift condition and the second bonus shift condition is satisfied is made if a bonus shift condition is satisfied in a bonus shift judgment by a lottery of a random number value in step S3 in the basic game (S11). As a result, if it is judged to satisfy the first bonus shift condition, to the game of shifted to a main bonus game, and, if it is decided that the second bonus shift condition is satisfied, the game is a sub-bonus game. When shifted to a main bonus game, Toby symbol T2 is displayed in any of display regions A1 through A3 where varying display stops first, for example, as shown in FIG. 9, in display region A2. Successively, Madonna symbol T2 is displayed in display region E2 in the same row of Toby symbol T2 among display regions E1 through E3 where varying display stops afterwards (S12). In this way, an announcement that a main bonus game is performed is made to a player. When shifted to a main bonus game, reels images A through E start to change automatically (S13). Free spin is performed here, and reel images A through E are halt-displayed in turn successively (S14). When all reel images A through E are halt-displayed, any of Wild symbol T1, bone symbol T6 and regular symbol is displayed in the display region A1 through A3, B1 through B3, C1 through C3, D1 through D3, and E1 through E3.

When the bone symbol T6 is displayed by a main bonus game in each display region, display of the bone symbol T6 changes to become wild symbol T1 (S15). The bone symbol T6 is controlled so as to be displayed a lot on a display region, and, when a main bonus game begins, many same symbols are displayed in a pay line with the bone symbol T6 changing into Wilde symbol T1. And, the judgment as to whether the same normal symbols are shown on the pay line is made (S16), and, if they are displayed, the number of coins corresponding to the types of the symbol which aligns with a pay line is paid (S17). Moreover, when the same normal symbol is not shown in the pay line, a coin is not paid, but most coins may be refunded in a main bonus game.

Because free spin is repeated ten times in total in this main bonus game, whether display is in the tenth in a reel image variation is judged (S18). As a result, when the tenth spin is not reached, the display is returned to step S13 and display is shifted to a reel image variation. Moreover, when the display reaches the tenth spin in a reel image variation, the main bonus game is terminated to shift to the basic game.

On the other hand, for example, when the second bonus shift condition is judged to be satisfied in step S11 and the game is shifted to a sub-bonus game, Toby symbol T2 is displayed in any of display regions A1 through A3 where the varying display stops at first to be halt-displayed, for example, in display region A2. Successively, Bulldog symbol T4 is displayed in display region E2 in the same row of Toby symbol T2 among display regions E1 through E3 where varying display stops afterwards (S19). In this manner, an announcement that a sub-bonus game is performed is made to a player. When shifted to a sub-bonus game, the reel images A through E start to change automatically as in the main bonus game (S20). Free spin is performed here, and successively, the reel images A through E is halt-displayed in turn (S21). When all the reel images A through E are halt-displayed, any of Wild symbol T1, bone symbol T6 and regular symbol is displayed on the display regions A1 through A3, B1 through B3, C1 through C3, D1 through D3, E1 through E3. In a sub-bonus game, even if the bone symbol T6 is displayed similarly as in the main bonus game, display does not change into the Wild symbol T1 and remains as it is. Therefore, the number of coins to be paid decreases compared to the case of the main bonus game. In such a manner, when the reel image is halt-displayed, whether the same regular symbols are shown in the pay line is judged (S22), if they are the number of coins corresponding to the types of the symbols aligned in the pay line is paid (S23). Moreover, when the same regular symbols are not indicated in the pay line, coin is not paid, but most coins may be refunded in the main bonus game thing.

Since free spin is repeated ten times in total in this sub-bonus game similarly as in the main bonus game, whether the reel image variation display is in the tenth spin is judged (S24). As a result, when the tenth spin is not reached, the game returns to step S23 to shift to the reel image variation display. Moreover, when the reel image variation display reaches the tenth spin, a sub-bonus game is terminated to shift to the basic game.

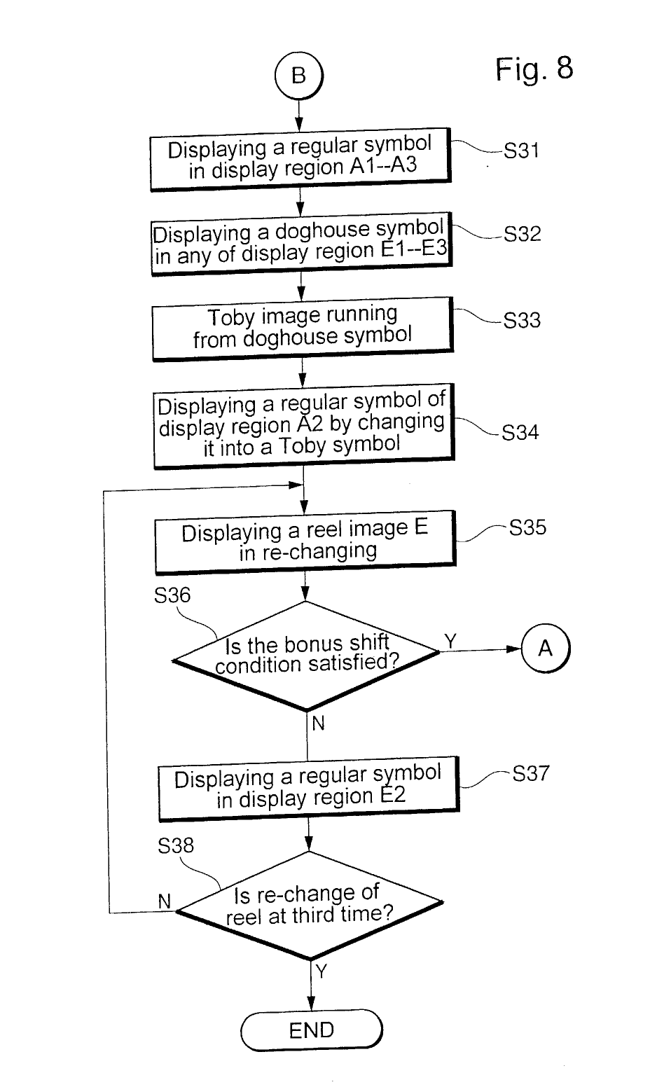

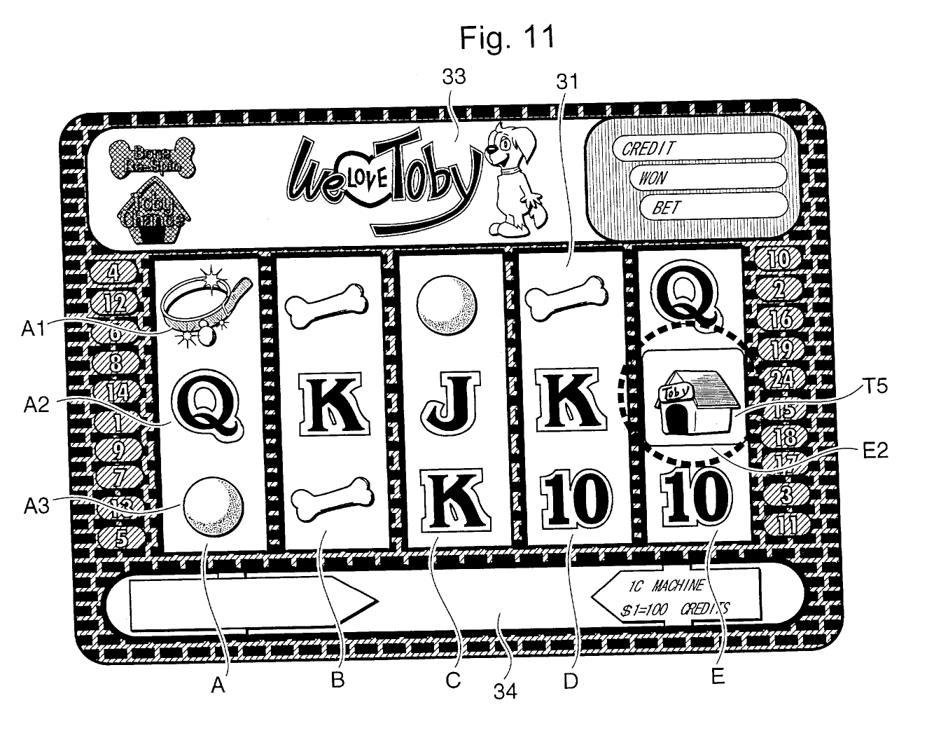

The flow of a chance game is explained next referring to FIG. 8. If it is judged that a specific condition is satisfied in step S4 in the basic game, CPU21 controls an image processing circuit 23 to display, as shown in FIG. 11, a regular symbol other than Toby symbol T2 in all display regions A1 through A3 where the varying display stops at first (S31). Then, the reel images B through D are stopped, and, a doghouse symbol T5 is displayed in any of display regions E1 through E3 where the varying display is stopped at last (display region E2 in FIG. 11) (S32). The Doghouse symbol T5 is displayed in the display region where the varying display stops at last so that a player can expect a shift to a chance game until the varying display stops, thereby raising attractiveness of the game so much.

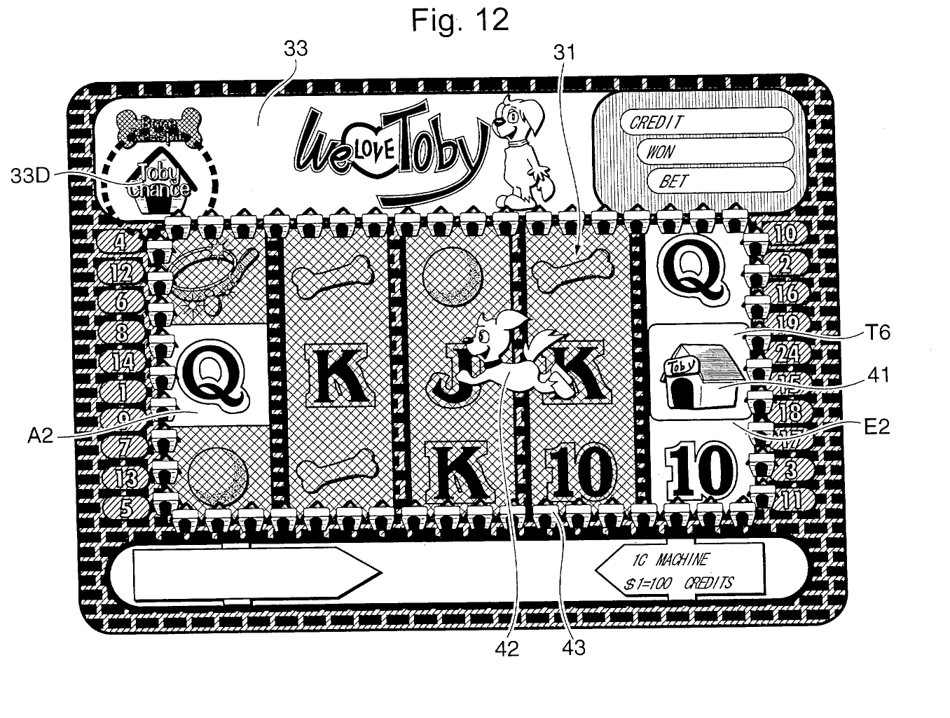

When Toby symbol T2 is not displayed in all the display regions A1 through A3 where varying display stops at first, and a doghouse symbol T5 is displayed on the display region E2 where the varying display stops at last, then, as shown in FIG. 12, a Toby image 42 of a motif of Toby running toward the display region A2 from the doghouse image 41 in the doghouse symbol T5 is displayed in (S33). At the same time, the display region A1 with little relevance in a chance game, A3, B1 through B3, C1 through C3, D1 through D3 are displayed in dark tone. Moreover, doghouse image 41 in upper display section 33 is displayed lighted. In this way, a shift to a chance game is announced to a player. Because a chance game is a game with high probability to shift to a bonus game, the player who has watched that this varying display stop feels sense of superiority when the game is shifted to a chance game, expanding a feeling of expectation to play a chance.

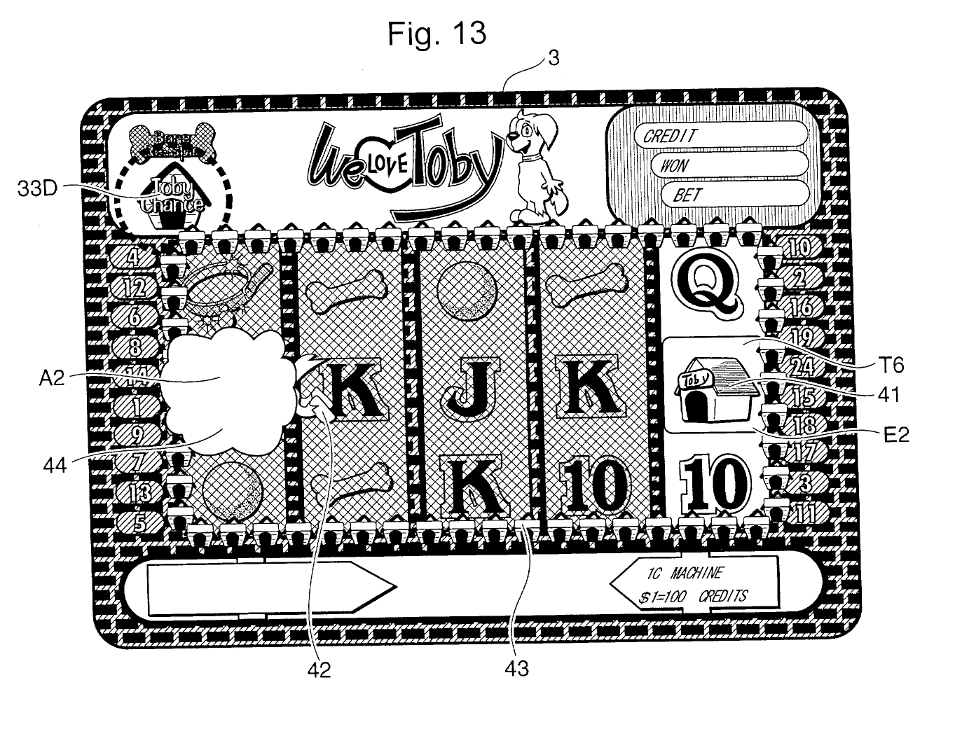

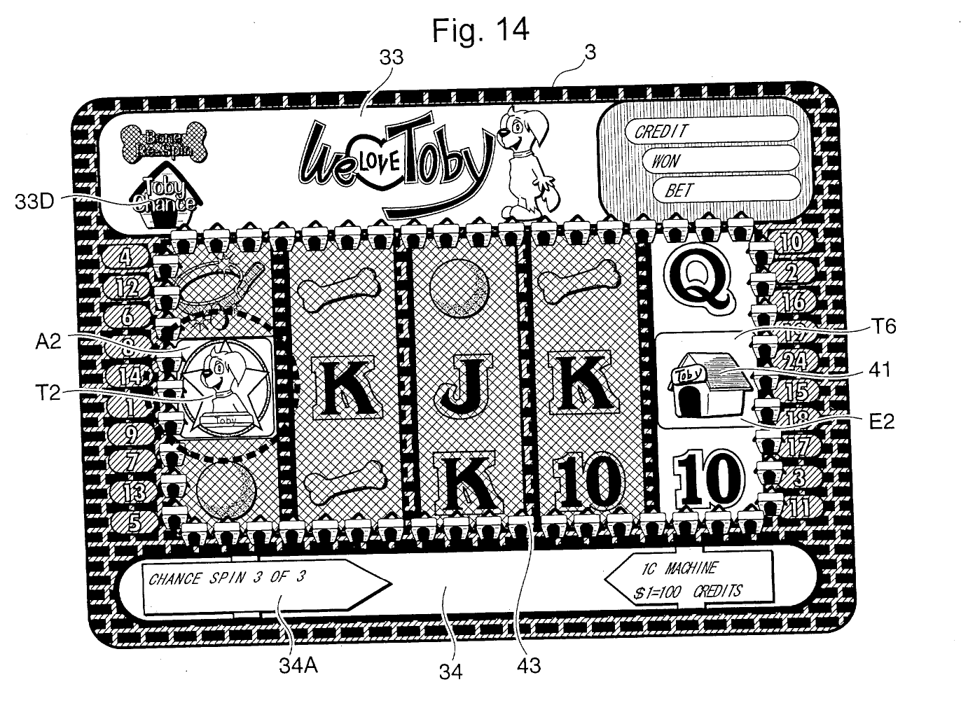

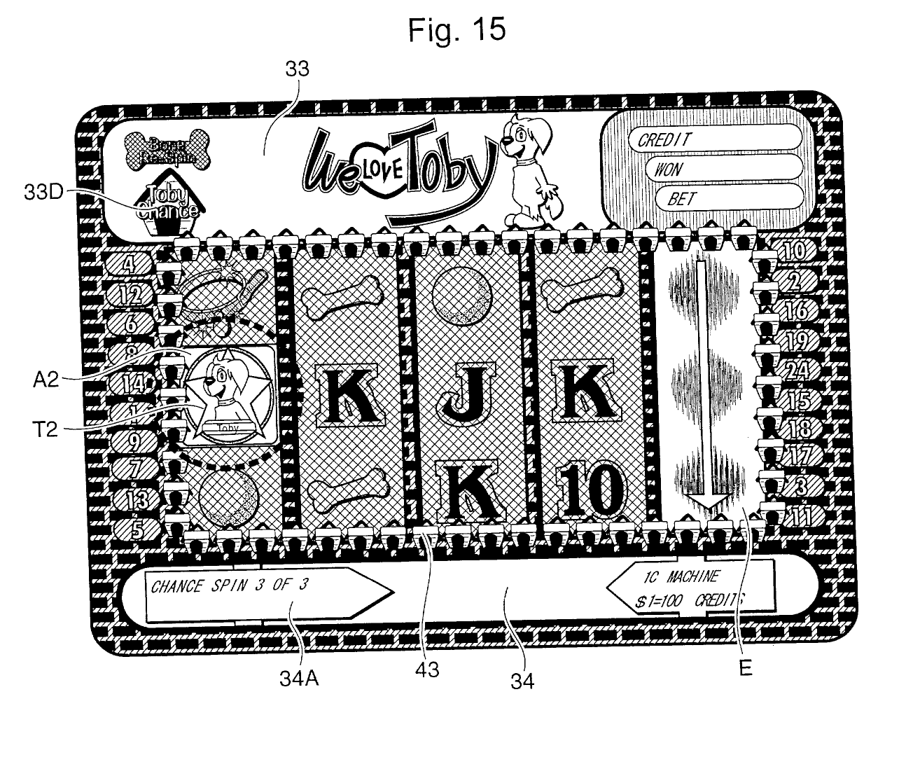

If Toby image 42 starting to run toward display region A2 is displayed, the varying display stops where Toby image 42 jumping into display region A2 is displayed afterwards as shown in FIG. 13. In the display region A2, a smoke image 44 that is imaged from the smoke occurring from the jumping Toby image 42 is displayed to cover a regular symbol displayed on the display region A2 by the smoke image 44. Then, a symbol displayed on the display region A2 which is a display region in the same row as display region E2 where the doghouse symbol T5 is displayed is changed from a regular symbol to Toby symbol T2 as shown in FIG. 14 (S34). Because the start of a bonus game is announced by aligning Toby symbol T2 and Madonna symbol T3 in the same row, Toby symbol T2 is displayed on the display region A2 first. If Toby symbol T21 is displayed, the most right side reel image E is variably displayed again as shown in FIG. 15 (S35). This re-varying display is repeated maximum three times, the chance game is performed three times at maximum, and a lottery is performed to determine whether the bonus shift condition is satisfied (S36). In this instance, “CHANCE SPIN 30F3” is displayed in the character information display 34A in the lower display 34, to announce a player that chance games are performed three times at maximum, and the number of times of the remaining chance game.

A lottery of a bonus shift condition in a chance game is configured in such a way that the range of a random number to occur is made small, and the first and second bonus shift conditions will be satisfied in higher probability than the lottery of a bonus shift condition in the basic game.

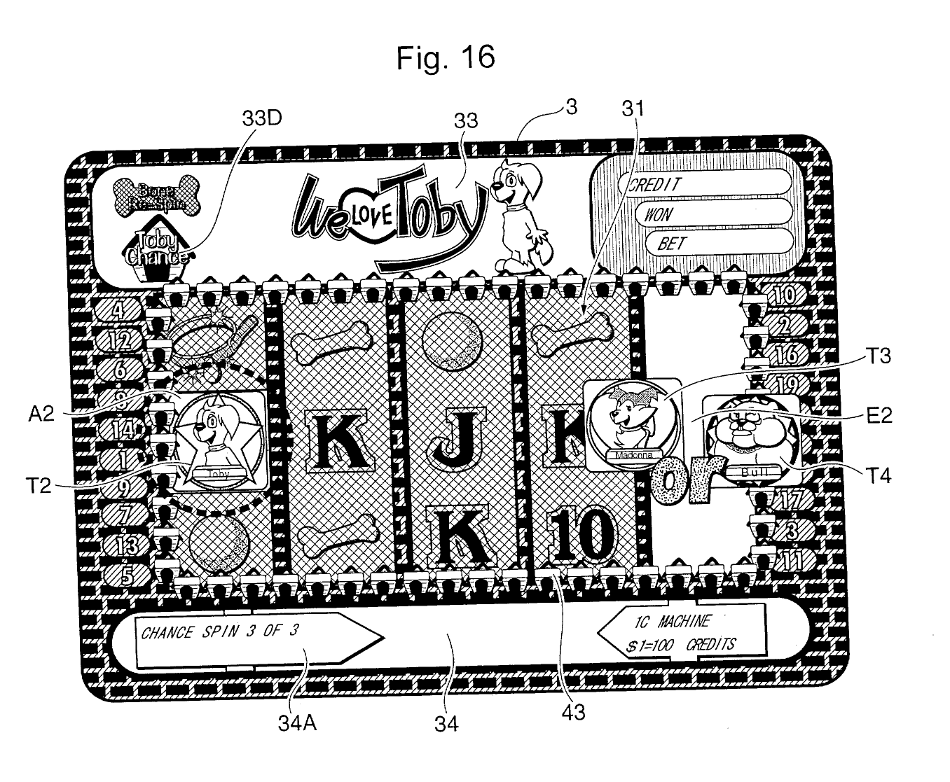

When the first bonus shift condition is satisfied in the first chance game, as shown in FIG. 16, Madonna symbol T3 is halt-displayed in the display region E2, the game is shifted to Maine bonus game, and a chance game is finished developmentally. Moreover, when the second bonus shift condition is satisfied, the bulldog symbol T4 is halt-displayed in the display region E2, the game is shifted to a sub-bonus game, and a chance game is terminated developmentally. If neither of these conditions is satisfied, a regular symbol is displayed in the display region E2 (S37), to announce to the player that there is no shift to a bonus game. Then, it is judged whether this reel re-change display is in the third time (S38).

Because this reel re-change display is the first one, the display is returned to the second re-change reel display (S35). The second chance game starts, and the most right reel image E starts the varying display. A regular symbol is halt-displayed in the display region E2, then, the most right side reel image E is indicated variably again successively. In this instance, the display of “30F3” changes into the display of “30F2” among displays of character information display 34A to announce the player that the second chance game is on. And, when a lottery of a bonus game is drawn similarly as in the case of the first chance game, and when the first bonus shift condition is satisfied, Madonna symbol T3 is halt-displayed in the display region E2 to shift to the main bonus game. Moreover, when bulldog symbol T4 is halt-displayed in the display region E2, and the game is shifted to a sub-bonus game when the second bonus shift condition is satisfied, and when neither of bonus shift conditions is satisfied, a usual symbol is halt-displayed in the display region E2, and successively the most right reel image E is displayed varyingly again to perform the third chance game. At this time, the display of “30F2” among the displays of the character information display 34A changes to display “30F1” announcing that it is the third time, namely the last chance game.

If the first and second bonus shift conditions are satisfied by the last chance game, according to the flow, the game is shifted to the main bonus game and a sub-bonus game respectively. Moreover, if neither of bonus shift conditions is satisfied, a chance game is terminated to shift to the basic game.

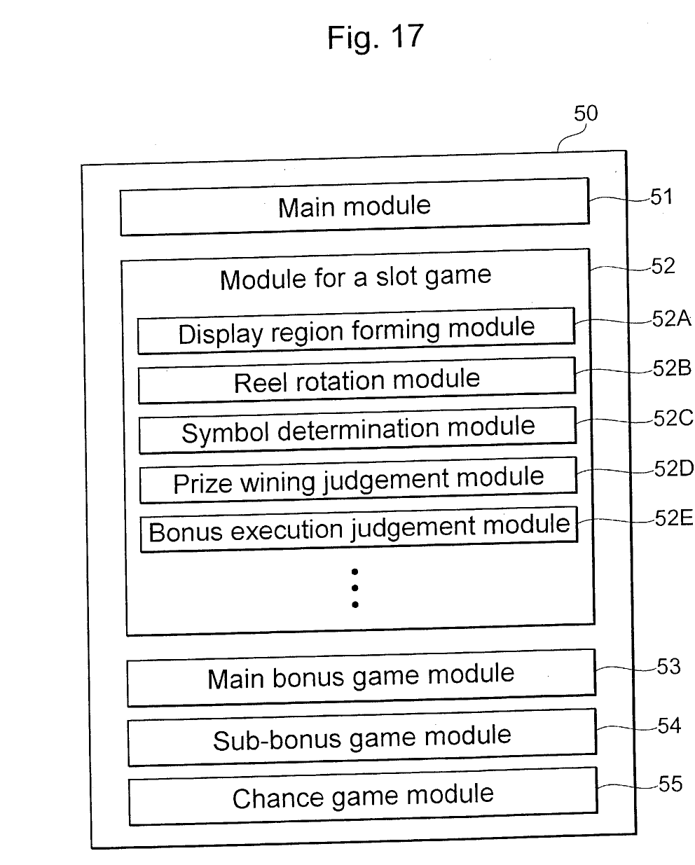

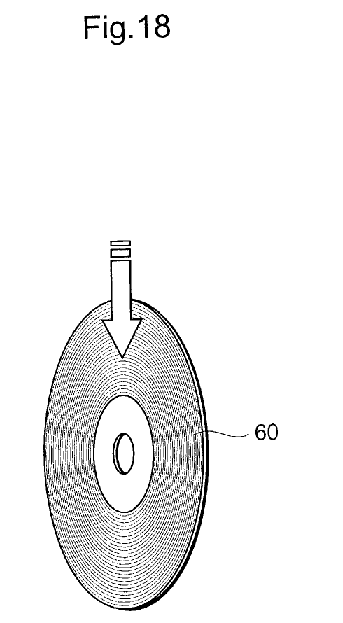

Next, the program according to the present invention, and a suitable embodiment of recording medium readable by the computer, in which the program is recorded, are explained referring to FIGS. 17 and 18.

FIG. 17 is a drawing showing each module of program 50 of this embodiment, and FIG. 18 is a drawing showing CD-ROM (a recording medium) 60 in which this program 50 is written.

The program 50 comprises the main module 51 supervising processing, and module 52 for slot games relating to the processing of a basic slot game, a main bonus game module 53 relating to the processing of the main bonus game, and sub-bonus game module 54 relating to the processing of a sub-bonus game, and a chance game module 55.

Furthermore, the module 52 for slot games comprises, at least, a display region forming module 52A, a reel turning module 52B, a symbol determination module 52C, a winning prize judgment module 52D and a bonus execution judgment module 52E.

The display region formation module 52A forms a plurality of display regions where symbols are displayed on display 3. The reel turning module 52B variably displays a reel images A through E on display 3. The symbol determination module 52C determines the symbol to be displayed on each display region based on a random number value. The winning prize judgment module 52D judges a winning prize based on an array of symbols displayed in each display region.

The bonus execution judgment module 52E judges whether a main bonus game or a sub-bonus game is performed based on a random number value. Because a computer executes each module, it is possible to realize each processing of FIGS. 7 and 8 in the slot machine 1.

The module 53 for main bonus games executes the main bonus games mentioned above, and a computer executes this module, thereby enabling the processing of the main bonus game. Moreover, the module 54 for sub-bonus games executes the sub-bonus games, and the computer executes this module, thereby enabling each processing of the sub-bonus game in the slot machine 1. The module 55 for chance games executes chance games, and a computer executes this module, thereby enabling each processing of a chance game in the slot machine 1.

In this way, it is possible to realize a game similar to that of the slot machine 1 by installing a program 50 such as obtained as a carrier wave via a communications network of Internet or CD-ROM 60 and program 50 recorded in the medium into various computers such as a personal computer or a personal digital assistant (PDA: Personal Digital Assistants). In other words, a development game is realized that can shift from the basic slot game to, a game of a main bonus game, a sub-bonus game and a chance game. Moreover, it is possible to realize a game of a development that can shift from a chance game to a main bonus game or a sub-bonus game, and further, that can shift from a sub-bonus game to a main bonus game.

Moreover, image data such as symbols or characters which are necessary for realizing a game, a pay table, and a table correlating symbols and bonus contents chosen in a bonus game may be incorporated in the program 50 or they may be installed in a computer from the source other than the program. Moreover, any module which is necessary for the processing performed in a slot machine 1 may be incorporated into the program 50 other than a module shown in FIG. 17.

Moreover, the recording medium may be any medium as for as information can be read by a computer. For example, a magnetic disk such as a floppy disks, a Laser Disk such as DVD, and a semiconductor storage device are applicable.

Suitable embodiment of the present invention has been explained as above, but the present invention is not limited to the embodiment as mentioned above. In the embodiment, a display region of three rows by five columns is set up in an image-display section, but, in addition, an array of a display region having various kinds of embodiments can be set up. Moreover, a Toby symbol is allowed to be displayed only on a reel image to be halt-displayed first, and a Madonna symbol and a bulldog symbol are allowed to be displayed only in a reel image to be stopped at last, but it is possible to set up an embodiment wherein symbols are displayed in other reel images. Besides, it is also possible to set up to display a bulldog symbol and a Madonna symbol in different reel images.

Moreover, it is not necessarily determined that the main bonus game and sub-bonus-game are started even if a doghouse symbol is displayed in the above-described embodiment. In contrast to this, it is possible to make a state where a main bonus game is determined at a point of time when a doghouse symbol is displayed or a state where a sub-bonus game is determined to start or either Maine bonus game or a sub-bonus game is determined to start.

On the other hand, in the aforementioned embodiment, main bonus and sub bonus games are set up as a bonus game, but only one kind of bonus game can be set up, and contrary more than three kinds of bonus games can be set up. Moreover, in the above-described embodiment, a chance game is set up as a different game, but such a state can be modified so that a different game is a bonus game.

As described above, according to the present invention, it is possible to provide a gaming apparatus with raised attractiveness, a control method of a gaming apparatus, a program, and a recording medium readable by a computer, by making displaying on a display announcing a game state various.

What is claimed is:

1. A gaming apparatus comprising;
a display having a plurality of display regions where symbols of a plurality of types are varyingly displayed, and a controller executing a predetermined program and controlling display contents of said display;
wherein said controller; determines said symbol which should be displayed on each said display region among a plurality of types of said symbols in accordance with said program; sequentially stops the display of symbols on a plurality of said display regions that are displayed varyingly; executes a basic game judging a prize based on an arrangement of symbols displayed on each of said display regions; displays a predetermined symbol on the display region where the varying display stops last among said plural display regions where the varyingly display stops in said display when a predetermined condition is fulfilled;
and executes an attractive game different from said basic game.

2. The gaming apparatus according to claim 1; wherein said predetermined symbol can be displayed only in the display region where the varying display stops last among a plurality of said display regions.

3. The gaming apparatus according to claim 1; wherein, after said predetermined symbol is displayed, a predetermined pattern is motion-displayed from said predetermined symbol toward a display region other than the display region where said predetermined symbol is displayed among a plurality of said display regions.

4. The gaming apparatus according to claim 2; wherein, after said predetermined symbol is displayed, a predetermined pattern is motion-displayed from said predetermined symbol toward a display region other than a display region where said predetermined symbol is displayed among a plurality of said display regions.

5. A control method of a gaming apparatus; comprising a display having a plurality of display regions where a plurality of types of symbols is varyingly displayed, and a controller executing a predetermined program and controlling a display content of said display;
comprising of the steps of; determining said symbol which should be displayed on each of said display regions among a plurality of types of said symbols, sequentially stopping the display of a symbol displayed varyingly in a plurality of said display regions, executing a basic game for judging a prize based on an arrangement of symbols displayed in each of said display regions, displaying a predetermined symbol in the display region where the varying display stops last among a plurality of said display regions where the varying display stops when predetermined condition is fulfilled, and executing an attractive game different from said basic game.

6. The control method of the gaming apparatus according to claim 5, after said predetermined symbol is displayed, comprising the step of, motion-displaying a predetermined pattern from said predetermined symbol toward a display region other than the display region where said predetermined symbol is displayed among a plurality of said display regions.

7. A program making a computer execute the steps of, displaying a plurality of display regions where a plurality of types of symbols is displayed varyingly on a display of a gaming apparatus, determining said symbol to be displayed on said symbol display region among a plurality of symbols, sequentially stopping the display of a symbol varyingly displayed on a plurality of said display regions, making the gaming apparatus execute a basic game for judging a prize based on the arrangement of symbols displayed on each of said display regions, making said display display a predetermined symbol on the display region where the varying display stops last when predetermined condition is fulfilled, and making the gaming apparatus execute an attractive game different from said basic game.

8. The program according to claim 7; making a computer execute a step of motion-displaying a predetermined pattern from said symbol toward a display region other than the display region displaying said predetermined symbol among a plurality of said display regions after displaying said predetermined symbol.

9. A computer readable recording medium characterized in that the program of claim 7 is recorded.

10. A computer readable recording medium characterized in that the program of claim 8 is recorded.
